(19) United States
(12) Patent Application Publication
(10) Pub. No.: US 2001/0006566 A1
(43) Pub. Date: Jul. 5, 2001

(54) Shell type needle roller bearing

(76) Inventors: Hideki Akamatsu, Shizuoka (JP); Shingo Kono, Shizuoka (JP)

Correspondence Address: WENDEROTH, LIND & PONACK, L.L.P., 2033 K Street, N.W., Suite 800, Washington, DC, 20006, US

(21) Appl. No.: 09/741,433

(22) Filed: Dec. 21, 2000

(30) Foreign Application Priority Data
Dec. 22, 1999 (JP) 11364303

(51) Int. Cl. F16C 43/04

(52) U.S. Cl. 384/559

(57) ABSTRACT

A needle roller bearing is proposed in which treating gas can infiltrate more easily into the bearing during carburizing/nitriding treatment to promote treatment inside the bearing. The needle rollers are prevented from coming out by an inward flange provided at one end of the outer shell and an outward flange provided at the other end of the inner shell, and an inwardly bent edge provided at the other end of the outer shell is superimposed on the outside of the outward flange of the inner shell to establish axial engagement between the outer shell and the inner shell. The diametric overlap amount between the outward flange of the inner shell and the bent edge of the outer shell is set to a minimum limit necessary to maintain engagement therebetween so that treating gas can infiltrate into the bearing through the gap at the overlap portion.

### BACKGROUND OF THE INVENTION

This invention relates to a shell type needle roller bearing and a method of manufacturing the same.

Shell type needle roller bearings are known in which a plurality of needle rollers retained by a retainer are arranged inside of an outer shell. Also, so-called full type shell type needle roller bearings are known in which needle rollers are retained not by a retainer but by flanges of the outer shell. Also, a manufacturing method is known in which the entire bearing is heat-treated after assembling to simplify the heat treatment step, prolong the life of the bearing by making the hardness uniform, and improve roundness of the outer shell. But needle rollers are sometimes subjected to heat treatment beforehand (Japanese patent publication 10-237620).

On the other hand, another type of needle roller bearing is known in which the inner and outer shells are unseparably joined together (Japanese patent publication 8-232948). The needle roller bearings of this type has such a structure that the needle rollers are prevented from coming out axially by an inward flange formed by diametrically inwardly bending one end of the outer shell and an outward flange formed by diametrically outwardly bending the other end of the inner shell. The inner and outer shells are unseparably joined together by superimposing an inwardly bent edge formed at the other end of the outer shell on the outside of the outward flange of the inner shell, thereby axially engaging the outer shell and the inner shell together. Also, in order to prevent them from being disengaged by the collision of a tool against the inward flange of the outer ring during pressing onto a shaft, one end of the inner shell slightly protrudes beyond the inward flange of the outer shell.

In the manufacturing steps of shell type needle roller bearings of the type in which the inner and outer shells are joined together, too, it is considered advantageous to heat-treat the entire bearing after assembly of the bearing for simplification of the heat-treatment step.

But this type of needle roller bearings have a problem that desired surface hardness is not obtained on the raceways of the inner and outer shells because a space surrounded by the inner and outer shells is formed, so that carburizing/nitriding tends to be insufficient because treating gas for such treatment does not infiltrate sufficiently into this space.

An object of this invention is to provide an improved shell type needle roller bearing of the type in which the inner and outer shells are joined together and its manufacturing method in which the above problems have been solved.

### SUMMARY OF THE INVENTION

According to this invention, there is provided a shell type needle roller bearing comprising an outer shell, an inner shell, a plurality of needle rollers disposed between the outer shell and the inner shell, the outer shell having an inward flange formed by diametrically inwardly bending one end thereof and an inwardly bent edge formed by diametrically inwardly bending the other end thereof, the inner shell having an outward flange formed by diametrically outwardly bending one end of the inner shell to prevent the needle rollers from coming out of the bearing, the outer shell and the inner shell being axially engaged together by superimposing an inwardly bent edge of the outer shell on the outer surface of the outward flange of the inner shell, characterized in that the diametric overlap amount between the outward flange of the inner shell and the inwardly bent edge of the outer shell is set to a minimum limit required to maintain engagement between the outer shell and the inner shell.

By this arrangement, since the diametric overlap amount between the outward flange of the inner shell and the inwardly bent edge of the outer shell is small, during carburizing/nitriding treatment, treating gas easily passes through the air gap at the overlap portion and infiltrates into the bearing to promote carburizing/nitriding treatment inside the bearing.

As another means for facilitating infiltration of treating gas into the bearing, the inner diameter of the inward flange of the outer shell may be set to a pitch circle diameter (PCD) or substantially PCD of the needle rollers. With this arrangement, it is possible to increase the gap between the inward flange of the outer shell and the outer surface of the inner shell, so that treating gas can easily infiltrate and also filling of grease is easy.

Also, the plate thickness of the outer shell may be formed thicker compared with that of the inner shell. With this arrangement, since the rigidity of the outer shell increases, it is possible to use its outer surface as e.g. the raceway for a cam follower.

In the above arrangement, the orientation of the inner shell may be reversed. That is, the shell type needle roller bearing may comprise an outer shell, an inner shell, a plurality of needle rollers disposed between the outer shell and the inner shell, the outer shell having an inward flange formed by diametrically inwardly bending one end thereof, the inner shell having an outward flange formed by diametrically outwardly bending one end thereof, the outer shell and the inner shell being axially engaged together by superimposing the inward flange of the outer shell on the outer surface of the outward flange of the inner shell, the outer shell having an inwardly bent edge formed by diametrically inwardly bending the other end thereof to prevent the needle rollers from coming out of the bearing, and the diametric overlap amount between the inward flange of the outer shell and the outward flange of the inner shell is set to a minimum limit necessary to maintain engagement between the outer shell and the inner shell.

In this case, since the diametric overlap amount between the outward flange of the inner shell and the inward flange of the outer shell is small, during carburizing/nitriding treatment, treating gas easily passes through the gap at the overlap portion and infiltrates into the bearing to promote carburizing/nitrid ing treatment inside the bearing.

In manufacturing the shell type needle roller bearing, a bearing assembly may be formed by assembling an unhardened outer shell, an unhardened inner shell, and hardened and tempered or unhardened needle rollers, and the bearing assembly is subjected to carburizing/nitriding treatment and tempering.

In assembling the bearing assembly, an unhardened retainer for rotatably retaining the needle rollers may be used.

Other features and objects of the present invention will become apparent from the following description made with reference to the accompanying drawings, in which:

### BRIEF DESCRIPTION OF THE DRAWINGS

FIG. 1 is a sectional view of an embodiment;

FIG. 2A is a partial sectional view of the outer shell of the same;

FIG. 2B is a partial sectional view of a bearing assembly of the same;

FIG. 3 is a sectional view of another embodiment; and

FIG. 4 is a sectional view of a full type needle roller bearing.

### DETAILED DESCRIPTION OF THE PREFERRED EMBODIMENT

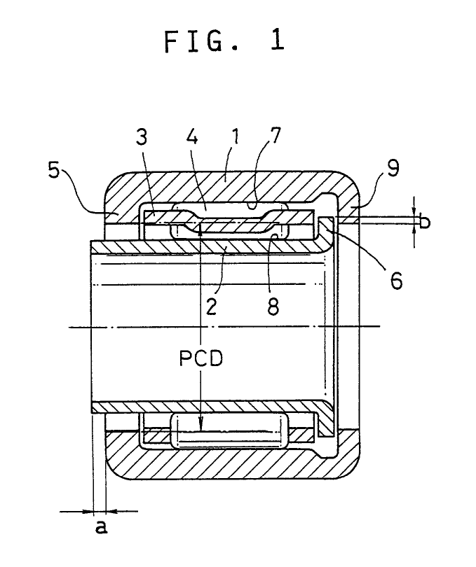

Embodiments of this invention will be described with reference to the attached drawings. The shell type needle roller bearing shown in FIG. 1 has a plurality of needle rollers 4 disposed between an outer shell 1 and an inner shell 2 and retained by a retainer 3.

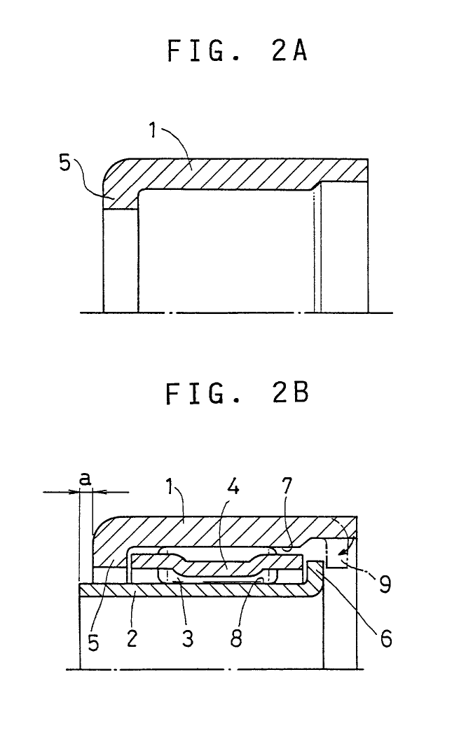

The outer shell 1 is a cylindrical member and has its one end radially inwardly bent to form an inward flange 5 (FIG. 2A). The inner shell 2 is also a cylindrical member and has its one end on the same side as the inward flange 5 formed so as to protrude outwardly by a small dimension a beyond the inward flange 5 of the outer shell 1. The inner shell 2 has its other end bent diametrically outwardly to form an outward flange 6. Between the raceway 7 of the outer shell 1 and the raceway 8 of the inner shell 2, the needle rollers 4 retained by the retainer 3 are arranged. The needle rollers 4, which are integral with the retainer 3, have their both ends prevented from axially coming off by the inward flange 5 of the outer shell 1 and the outward flange 6 of the inner shell 2.

Also, on the inner surface of the outer shell 1 at its other end, the wall thickness is slightly reduced to make this portion relatively thin. This portion is bent diametrically inwardly to form an inwardly bent edge 9 (see the arrow of FIG. 2B). By superimposing this inwardly bent edge 9 on the outside of the outward flange 6 of the inner shell 2, axial engagement between the outer shell 1 and the inner shell 2 is established.

With this shell type needle roller bearing having this structure, its constituent members are worked and assembled without subjecting them to heat treatment of any kind, i.e. without calcining. After assembling, the entire bearing assembly is subjected to carburizing/nitriding treatment and then to tempering to impart required hardness to the constituent members. But as the needle rollers 4, ones that have been hardened and tempered beforehand are sometimes used and unhardened ones are sometimes used.

It is necessary to feed treating gas all over the inside of the bearing in the carburizing/nitriding treatment. For this purpose, the following arrangements can be employed.

The first arrangement is to set the diametric overlap amount b between the bent edge 9 of the outer shell 1 and the outward flange 6 of the inner shell 2 to a minimum limit (e.g. 0.5 mm) necessary to maintain the engagement between the inner and outer shells. The larger the overlap amount, the larger the sealability at this portion. Conversely, the smaller the overlap amount, the lower the sealability, so that treating gas can pass through the gap at the overlap portion and infiltrate into the bearing.

The second arrangement is to set the inner diameter of the inward flange 5 of the outer shell 1 to as large a value as possible. Specifically, it is set to a pitch circle diameter (PCD) or substantially PCD of the needle rollers 4. By this arrangement, the gap between the inward flange 5 of the outer shell 1 and the inner shell 2 increases, so that gas can easily pass. Also, filling of grease becomes easier, too.

The plate thickness of the outer shell 1 is sometimes set at a value larger than that of the inner shell 2. This arrangement is adopted if the outer shell 1 is used as a raceway for a cam follower by increasing its rigidity.

Specific figures in the above embodiment are as shown in Table 1.

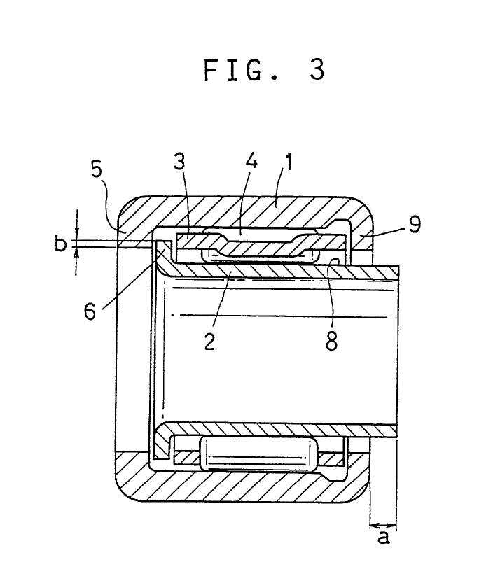

Next, in another embodiment shown in FIG. 3, the position of the inner shell 2 is reversed, the inward flange 5 of the outer shell 1 and the outward flange 6 of the inner shell 2 are superimposed, and their diametric overlap amount b is set to a minimum limit required for the engagement between the inner and outer shells 1, 2. Also, the other end of the outer shell 1 is formed relatively thin, and an inwardly bent edge 9 is provided by bending this portion to prevent the needle rollers 4 from coming off axially. The other end of the inner shell 2 protrudes outwardly by a small dimension a beyond the inwardly bent edge 9 of the outer shell 1. Other structures and the manufacturing method are the same as above.

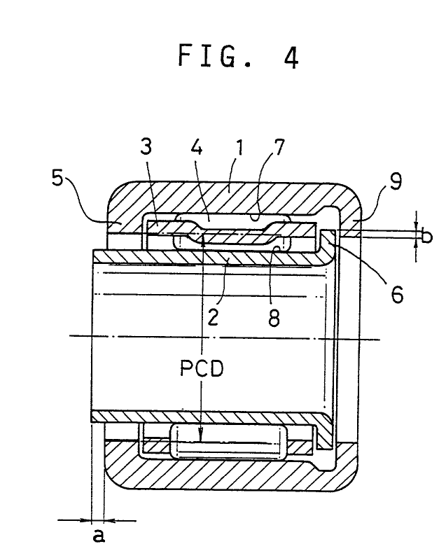

In these embodiments, description was made of the structure of shell type needle roller bearings of the type in which the needle rollers 4 are retained by the retainer 3 and their manufacturing method. The same is true for so-called full type bearings as shown in FIG. 4. In this case, no cage is provided and the needle rollers 4 have their both ends abutting the inward flange 5 of the outer shell 1 and the outward flange 6 of the inner shell 2. Since other structures and the manufacturing method are the same as above, only the same numerals are affixed for the same parts and description is omitted.

As described above, according to this invention, in a shell type needle bearing of the type in which the inner and outer shells are joined together with the needle rollers disposed between the outer shell and the inner shell, it is possible to sufficiently infiltrate treating gas into the bearing in the carburizing/nitriding treatment, which is carried out after the bearing has been assembled, so that the effect of treatment such as hardening of the raceways extends to the entire bearing.

TABLE 1

| | Standard product | Present invention |
|---|---|---|
| Inner diameter of | 7.6 | 8.3 |
| bent edge of outer shell | | |
| Inner diameter of | 7.4 | 8.4 |
| inward flange of inner shell | | |
| Outer diameter of | 9.6 | 9.0 |
| inward flange of outer shell | | |
| Thickness of outer shell | 0.5 | 1.25 |
| Thickness of inner shell | 0.5 | 0.5 |
| | | (in centimeter) |

What is claimed is:

1. A shell type needle roller bearing comprising an outer shell, an inner shell, a plurality of needle rollers disposed between said outer shell and said inner shell, said outer shell having an inward flange formed by diametrically inwardly bending one end thereof and an inwardly bent edge formed by diametrically inwardly bending the other end thereof, said inner shell having an outward flange formed by diametrically outwardly bending one end of said inner shell to prevent said needle rollers from coming out of the bearing, said outer shell and said inner shell being axially engaged together by superimposing an inwardly bent edge of said outer shell on the outer surface of said outward flange of said inner shell, characterized in that the diametric overlap amount between said outward flange of said inner shell and said inwardly bent edge of said outer shell is set to a minimum limit required to maintain engagement between said outer shell and said inner shell.

2. The shell type needle roller bearing as claimed in claim 1 wherein the inner diameter of said inward flange of said outer shell is set to substantially the pitch circle diameter of said needle rollers.

3. The shell type needle roller bearing as claimed in claim 1 or 2 wherein said outer shell has a smaller thickness than that of said inner shell.

4. The shell type needle roller bearing as claimed in any of claims 1-3 wherein said inner shell has its one end protruding outwardly beyond said inward flange of said outer ring.

5. The shell type needle roller bearing as claimed in any of claims 1-4 wherein said needle rollers are retained by a retainer.

6. A shell type needle roller bearing comprising an outer shell, an inner shell, a plurality of needle rollers disposed between said outer shell and said inner shell, said outer shell having an inward flange formed by diametrically inwardly bending one end thereof, said inner shell having an outward flange formed by diametrically outwardly bending one end thereof, said outer shell and said inner shell being axially engaged together by superimposing said inward flange of said outer shell on the outer surface of said outward flange of said inner shell, said outer shell having an inwardly bent edge formed by diametrically inwardly bending the other end thereof to prevent said needle rollers from coming out of the bearing, characterized in that the diametric overlap amount between said inward flange of said outer shell and said outward flange of said inner shell is set to a minimum limit required to maintain engagement between said outer shell and said inner shell.

7. A method of manufacturing a shell type needle roller bearing wherein in manufacturing the shell type needle roller bearing as claimed in any of claims 1-6, a bearing assembly is formed by assembling an unhardened outer shell, an unhardened inner shell, and hardened and tempered or unhardened needle rollers, and said bearing assembly is subjected to carburizing/nitriding treatment and tempering.

8. The method of manufacturing a shell type needle roller bearing as claimed in claim 7 wherein in assembling said bearing assembly, an unhardened retainer for rotatably retaining said needle rollers is used.
